(19) United States
(12) Patent Application Publication
(10) Pub. No.: US 2006/0202586 A1
(43) Pub. Date: Sep. 14, 2006

(54) Stator of motor

(75) Inventors: Jang Ho Shim, Seoul (KR); Jin Soo Park, Inchun-si (KR); Sung Ho Lee, Anyang-si (KR); Byung Taek Kim, Ansan-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/328,093

(22) Filed: Jan. 10, 2006

(30) Foreign Application Priority Data
Mar. 8, 2005 (KR) 2005-19138

(51) Int. Cl. H02K 1/28; H02K 1/18

(52) U.S. Cl. 310/216; 310/218

(57) ABSTRACT

A stator of a motor includes a yoke; a plurality of teeth located along a circumference of the yoke, each of the teeth including a neck, the necks being staggered with respect to a line extending along a circumferential direction of the yoke; and coils wound around the necks.

This Nonprovisional Application claims priority under 35 U.S.C. §119(a) on Patent Application No. 10-2005-0019138 filed in Korea on Mar. 8, 2005, the entire contents of which are hereby incorporated by reference.

### BACKGROUND OF THE INVENTION

1. Field of the Invention

The present invention relates to a motor, and more particularly, to a stator of a motor in which the necks of the teeth in the circumferential direction of the stator are alternately arranged in the axial direction.

2. Description of the Related Art

FIG. 1 is a perspective view illustrating a stator of a conventional motor. FIG. 2 is a partially cutaway perspective view illustrating a stator of a conventional motor. FIG. 3 is a cross-sectional view taken along the line A-A in FIG. 1. FIG. 4 is a cross-sectional view taken along the line B-B in FIG. 2.

The conventional motor shown in FIG. 1 to 4 is an inner rotor motor in which a rotor 10 is rotatably installed in a stator 20 and rotates due to the interaction between the rotor 10 and the stator 20.

A rotor 10 includes a rotor core 12 disposed in the stator 20 to rotate while maintaining a predetermined gap and a plurality of magnets embedded in the rotor core 12 in the circumferential direction.

The stator 20 includes a ring-shaped yoke 22, a plurality of teeth 24 arranged on the inner wall of the yoke 22 in the circumferential direction, and coils 26 wound around the teeth 24 and electrically connected to an external electric power.

The teeth 24 include necks 23, protruded from the inner wall of the yoke 22, around which the coils 26 are wound, and tips 25 disposed at the ends of the necks 23 to face the rotor 10. The axial ends of the necks 23 of the teeth 24 have outwardly convex round shapes to minimize the end-turn portions of the coils 26.

As shown in FIG. 5, the end-turn portions 26′ of the coils 26 are portions protruded over the necks 23 of the teeth 24. Since the coils 26 cannot closely contact the axial ends of the necks 23 of the teeth 24 when the axial ends of the necks 23 of the teeth 24 are flat, the end-turn portions 26′ are increased. When the end-turn portions 26′ of the coils 26 are increased, the weight of the coils 26 is increased and the copper loss of the coils 26 is also increased.

FIG. 6 illustrates the relation between the lamination factor and weight of winding with respect to the size of necks of conventional teeth. As shown in FIG. 6, if the necks 23 of the teeth 24 have a ratio of the width 23W with respect to an axial length 23L of approximately 1 (one), the weight of windings can be reduced.

In other words, as shown in FIG. 6, when the ratio of the width 23W with respect to the axial length 23L approximates 1 (one), namely, when the cross section is about circular, weight of windings, i.e., the quantity of coils 26 is decreased.

However, as shown in FIG. 6, the configuration of the necks 23 of the teeth 24 cannot have a circular cross section because of the restriction due to the lamination factor of the windings.

In particular, the lamination factor is defined by the intervals between the teeth 24, i.e., a percentage of the size of portions around which the coils 26 are wound with respect to the size of the slot S, and is generally, due to the interference between the coils 26 wound around respective teeth 24, about 70% to 80%.

However, in the stator 20 of the conventional motor, as described above, since the configuration of the necks 23 of the teeth 24 are limited by the lamination factor, there are limitations to reduce the turns of the coils 26 and the weight of the coils with respects to the same turns of the coils.

### SUMMARY OF THE INVENTION

Therefore, the present invention has been made in view of the above and/or other problems, and it is an object of the present invention to provide a stator of a motor in which the necks of the teeth are misaligned with circumferentially oriented neighboring necks neighbored in the axial direction such that the lamination factor is improved.

In accordance with one aspect of the present invention, the above and other objects can be accomplished by providing a stator of a motor including: a yoke; a plurality of teeth located along a circumference of the yoke, each of the teeth including a neck, the necks being staggered with respect to a line extending along a circumferential direction of the yoke; and coils wound around the necks.

In accordance with another aspect of the present invention, the above and other objects can be accomplished by providing a stator of a motor including a yoke; a plurality of teeth located along a circumference of the yoke, each of the teeth including: a neck, each of the necks having a circular cross section; and coils wound around the necks.

In accordance with another aspect of the present invention, the above and other objects can be accomplished by providing a stator of a motor including a rotor; and a stator, the stator including a plurality of stator core pieces along a circumference of the stator, each of the stator core pieces including: a yoke piece, the yoke piece including a protrusion and a recess, the protrusion protruding from a first side of the yoke piece in the circumferential direction of the stator, the recess being located on a second side of the yoke piece in the circumferential direction of the stator opposite to the first side for receiving the protrusion of an adjacent yoke piece; and a tooth located on the yoke piece.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 is a perspective view illustrating a stator of a conventional motor;

FIG. 2 is a partially cutaway perspective view illustrating a stator of a conventional motor;

FIG. 3 is a cross-sectional view taken along the line A-A in FIG. 1;

FIG. 4 is a cross-sectional view taken along the line B-B in FIG. 2;

FIG. 5 illustrates an end coil of a stator of the conventional motor;

FIG. 6 illustrates the relation between the lamination factor and weight of winding with respect to the size of necks of conventional teeth;

FIG. 7 is a perspective view illustrating a stator of a motor according to an embodiment of the present invention;

FIG. 8 is a cross-sectional view taken along the line C-C in FIG. 7;

FIG. 9 is a partially cutaway perspective view illustrating the stator of the motor according to an embodiment of the present invention;

FIG. 10 is an unassembled view of the teeth of the stator of the motor according to an embodiment of the present invention; and

FIG. 11 illustrates the process of assembling the stator of the motor according to an embodiment of the present invention.

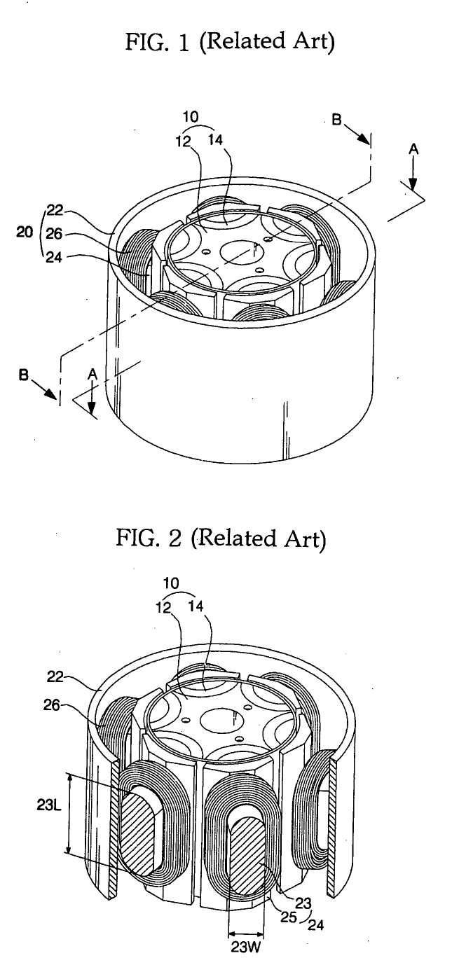

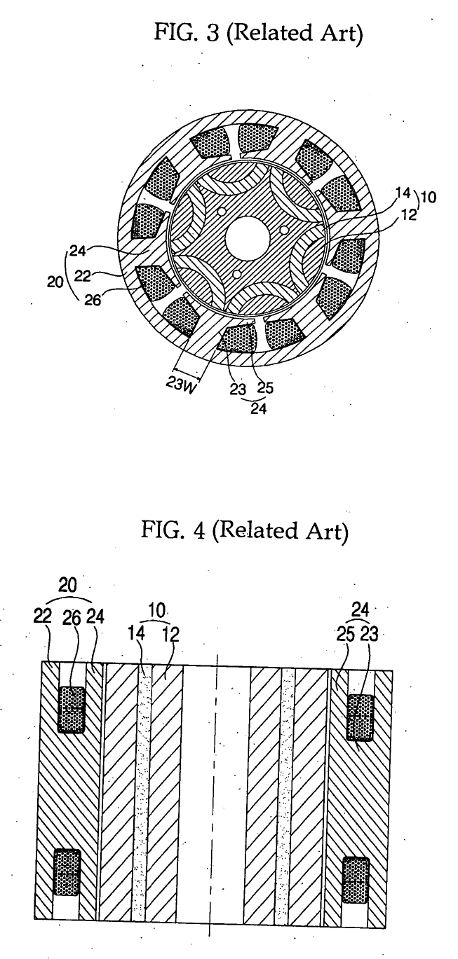

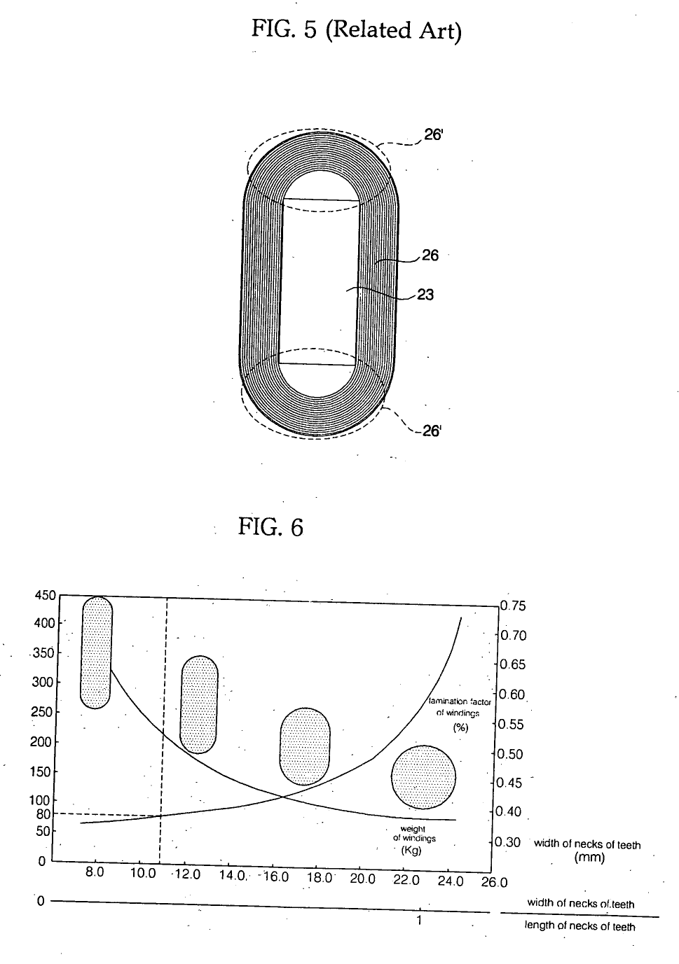

### DESCRIPTION OF THE ILLUSTRATED EMBODIMENTS

Hereinafter, the embodiments of a stator of a motor according to the present invention will be described with reference to the accompanying drawings.

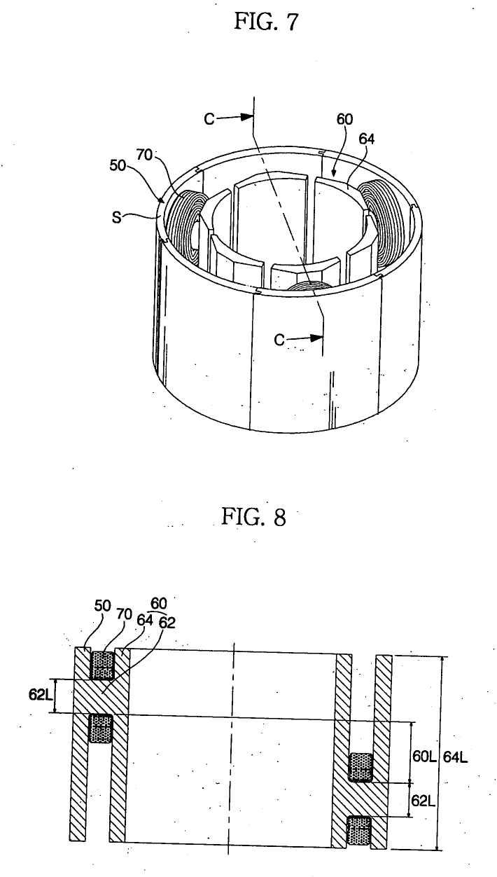

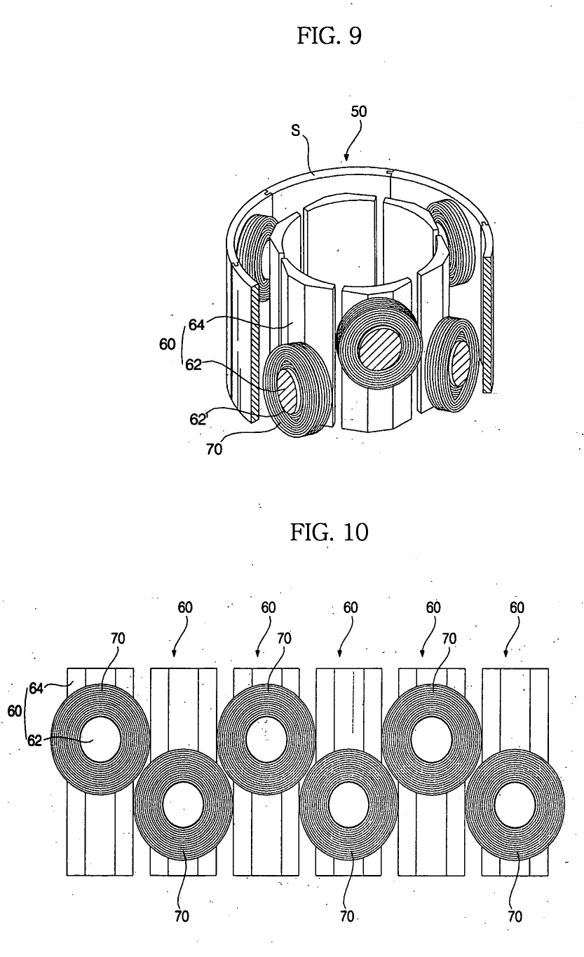

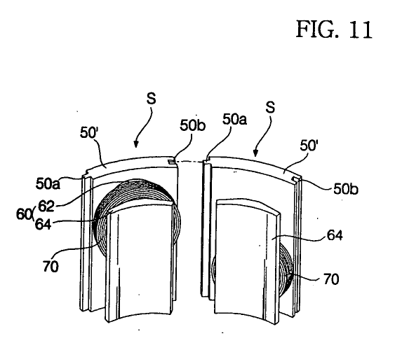

FIG. 7 is a perspective view illustrating a stator of a motor according to an embodiment of the present invention. FIG. 8 is a cross-sectional view taken along the line C-C in FIG. 7. FIG. 9 is a partially cutaway perspective view illustrating the stator of the motor according to an embodiment of the present invention. FIG. 10 is an unassembled view, of the teeth of the stator of the motor according to an embodiment of the present invention. FIG. 11 is illustrates the process of assembling the stator of the motor according to an embodiment of the present invention.

The motor will be described with reference to FIGS. 7 to 11, and is an inner rotor motor in which a rotor is rotatably installed in a stator. The motor shown in FIGS. 7 to 11 includes a ring-shaped yoke 50, teeth 60 arranged on the inner wall of the yoke 50 in the circumferential direction, and coils 70 wound around the teeth 60.

The teeth 60 include necks 62 to which the yoke 50 is connected and around which the coils 70 are wound, and tips 64 connected to the rotor-sided ends of the necks 62 and facing the rotor. The axial ends of the necks 62 of the teeth 60 have outwardly convex round shapes to minimize the end-turn portions of the coils 70.

Particularly, the axial length 62L of the necks 62 is shorter than the length of the yoke 50, and the axial positions of the necks 62 are different from those of the neighboring necks 62 of the teeth 60 such that spaces required for winding the coils 70 are secured. In an embodiment, the necks 62 are staggered with respect to a line extending along the circumferential direction of the yoke 50. In the illustrated embodiment, the necks 62 are staggered in a zigzag fashion with respect to a midline having an equal distance to an upper end and a lower end of the yoke. In the illustrated embodiment, two immediately adjacent necks 62 are respectively located on two sides of the line and the necks 62 of every tooth 60 are located on a same side of the line. In an embodiment, the necks 62 of every other tooth 60 are substantially aligned with respect to the circumferential direction of the yoke.

The above-mentioned necks 62 of the teeth 60 are symmetric with respect to the necks 62 of the circumferentially oriented neighboring teeth 60 about the axial direction such that more wide winding space for the coils 70 can be secured.

In addition, since the necks 62 of the teeth 60 are spaced apart from the necks 62 of the circumferentially oriented neighboring teeth 60 by a predetermined distance 60L in the axial direction of the yoke 50, the cross section of the necks 62 may be substantially circular such that the weight of the coils 70 can be minimized with the same cross-sectional areas of the necks 62. The tips 64 of the teeth 60 preferably have the same axial length 64L as the yoke 50 such that the core loss can be minimized.

Meanwhile, the combination of the yoke 50 and the teeth 60 is referred to as a stator core, and the stator core is preferably manufactured via iron powder metallurgy such that the configuration can be freely designed.

In addition, since the axial positions of the necks 62 of the teeth 60 are different from those of the necks 62 of the circumferentially oriented neighboring teeth 60, the stator core may be divided into several parts and assembled for easy design of a mold for manufacturing the stator core.

In other words, the stator core may include a plurality of stator core pieces S in which the stator core is divided in the circumferential direction. In an embodiment, the number of the stator core pieces S equals the number of teeth 60 forming a single stator core.

Each of the stator core pieces S may include one of yoke pieces 50′ in which the yoke 50 is circumferentially divided into the same number as the number of the teeth 60 forming a single stator core, and a tooth 60 integrally formed with a single yoke piece 50′, such that the respective stator core pieces S have the same configuration.

Additionally, a single stator core piece S may include a protrusion 50a circumferentially protruded from the side of the single stator core piece S to another circumferentially oriented neighboring stator core piece S, and a recess 50b, formed on the other side of the single stator core piece S, into which the protrusion 50a of another circumferentially oriented neighboring stator core piece S is inserted so that the stator core piece S can be coupled with another circumferentially oriented neighboring stator core pieces S.

Since the necks 62 of the teeth 60 are spaced apart from the necks 62 of circumferentially oriented neighboring teeth 60 and have a substantially circular cross-section, the weight of windings and copper loss are minimized with respect to the same turns of windings or the turns of the coils 70 can be increased.

Although not depicted in the drawings, the present invention can also apply to an outer rotor motor in which a rotor is rotatably installed outside a stator.

As described above, since the illustrated stator of a includes a yoke, a plurality of teeth circumferentially arranged on the circumference of the yoke, and coils wound around the teeth, particularly, the necks of the teeth are shorter than the yoke and are spaced apart from the necks of circumferentially oriented neighboring teeth in the axial direction, the lamination factor of windings can be enhanced. The necks of the teeth may have a substantially circular cross section so that the weight of windings can be reduced with respect to the same turns of windings.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A stator of a motor comprising:
a yoke;
a plurality of teeth located along a circumference of the yoke, each of the teeth including a neck, the necks being staggered with respect to a line extending along a circumferential direction of the yoke; and
coils wound around the necks.

2. The stator of claim 1, wherein the necks are staggered in a zigzag fashion.

3. The stator of claim 1, wherein the line is a midline having an equal distance to an upper end and a lower end of the yoke.

4. The stator of claim 1, wherein two immediately adjacent necks are respectively located on two sides of the line.

5. The stator of claim 4, wherein the necks of every other tooth are located on a same side of the line.

6. The stator of claim 5, the necks of every other tooth are substantially aligned with respect to the circumferential direction of the yoke.

7. The stator of claim 1, wherein the necks have a circular cross section.

8. The stator of claim 1, wherein each of the teeth includes a tip located at a first end of the neck opposite to a second end of the neck facing the yoke, the tip having a substantially same axial length as the yoke.

9. The stator of claim 1, wherein the yoke includes a plurality of yoke pieces along the circumferential direction of the yoke.

10. The stator of claim 6, wherein each of the teeth is formed on one of the yoke pieces.

11. The stator of claim 6, wherein each of the yoke pieces includes:
a protrusion protruding from a first side of the yoke piece in the circumferential direction of the yoke; and
a recess on a second side of the yoke piece in the circumferential direction of the yoke opposite to the first side for receiving the protrusion of an adjacent yoke piece.

12. The stator of claim 1, wherein the material of the yoke and the teeth are iron powder.

13. A stator of a motor comprising:
a yoke;
a plurality of teeth located along a circumference of the yoke, each of the teeth including a neck, each of the necks having a circular cross section; and
coils wound around the necks.

14. The stator of claim 13, wherein each of the teeth includes a neck, the necks being staggered with respect to a line extending along a circumferential direction of the yoke.

15. The stator of claim 14, wherein the necks are staggered in a zigzag fashion.

16. The stator of claim 14, wherein the line is a midline having an equal distance to an upper end and a lower end of the yoke.

17. The stator of claim 14, wherein two immediately adjacent necks are respectively located on two sides of the line.

18. The stator of claim 17, wherein the necks of every other tooth are located on a same side of the line.

19. The stator of claim 18, the necks of every other tooth are substantially aligned with respect to the circumferential direction of the yoke.

20. The stator of claim 13, wherein a length of the necks in an axial direction of the yoke is shorter than a length of the yoke in the axial direction of the yoke.

21. The stator of claim 13, wherein each of the teeth includes a tip located at a first end of the neck opposite to a second end of the neck facing the yoke, the tip having a substantially same axial length as the yoke.

22. The stator of claim 13, wherein the yoke includes a plurality of yoke pieces along the circumferential direction of the yoke.

23. The stator of claim 22, wherein each of the teeth is formed on one of the yoke pieces.

24. The stator of claim 22, wherein each of the yoke pieces includes:
a protrusion protruding from a first side of the yoke piece in the circumferential direction of the yoke; and
a recess on a second side of the yoke piece in the circumferential direction of the yoke opposite to the first side for receiving the protrusion of an adjacent yoke piece.

25. The stator of claim 13, wherein the material of the yoke and the teeth are iron powder.

26. A motor, comprising:
a rotor; and
a stator, the stator including a plurality of stator core pieces along a circumference of the stator, each of the stator core pieces including:
a yoke piece, the yoke piece including a protrusion and a recess, the protrusion protruding from a first side of the yoke piece in the circumferential direction of the stator, the recess being located on a second side of the yoke piece in the circumferential direction of the stator opposite to the first side for receiving the protrusion of an adjacent yoke piece; and
a tooth located on the yoke piece.

27. The motor of claim 26, wherein each of the teeth includes a neck, the necks being staggered with respect to a line extending along a circumferential direction of the stator.

28. The motor of claim 27, wherein the necks are staggered in a zigzag fashion.

29. The motor of claim 27, wherein the line is a midline having an equal distance to an upper end and a lower end of the yoke.

30. The motor of claim 27, wherein two immediately adjacent necks are respectively located on two sides of the line.

31. The motor of claim 27, wherein the necks of every other tooth are located on a same side of the line.

32. The motor of claim 31, the necks of every other tooth are substantially aligned with respect to the circumferential direction of the yoke.

33. The motor of claim 27, wherein the necks have a circular cross section.
